(19) United States
(12) Patent Application Publication
(10) Pub. No.: US 2009/0049375 A1
(43) Pub. Date: Feb. 19, 2009

(54) SELECTIVE PROCESSING OF INFORMATION FROM A DIGITAL COPY OF A DOCUMENT FOR DATA ENTRY

(75) Inventors: Timothy Alan Aughenbaugh, De Smet, SD (US); Jonathan David Gross, Woodbury, MN (US); Rodney Dean May, Brookings, SD (US)

Correspondence Address: WESTMAN CHAMPLIN & KELLY, P.A., SUITE 1400, 900 SECOND AVENUE SOUTH, MINNEAPOLIS, MN, 55402-3244, US

(73) Assignee: Talario, LLC, Colorado Springs, CO (US)

(21) Appl. No.: 12/108,789

(22) Filed: Apr. 24, 2008

Related U.S. Application Data
(60) Provisional application No. 60/956,685, filed on Aug. 18, 2007.

(51) Int. Cl. G06F 3/048; G06F 17/00

(52) U.S. Cl. 715/253; 715/780

(57) ABSTRACT

A method for entering data from a digital copy of a document is provided. The method includes accessing the digital copy of the document and creating one or more segments of the digital copy. At least one segment of the digital copy is displayed such that the at least one segment is overlaid on a user interface of an application. The method also includes receiving entry of data from a user into the user interface of the application using an input device while the at least one segment is visible over the user interface.

### CROSS-REFERENCE TO RELATED APPLICATION

The present application is based on and claims the benefit of U.S. provisional patent application Ser. No. 60/956,685, filed Aug. 18, 2007, the content of which is hereby incorporated by reference in its entirety.

### BACKGROUND

The present disclosure relates generally to collection of data for information systems and more specifically, but not by limitation, to processing of information from a digital copy of a paper document for data entry into an information system.

Since computers first came into use, people have been entering data from paper forms and documents into computer information systems. Often this process involves manual entry of handwritten or printed information by visually looking at the paper document, and then typing what is seen into a computer application. Long regarded as tedious, this process suffers from the inefficiencies of requiring the paper to be near the computer where data entry will occur, and also by requiring the operator to continually alternate between looking at the information on the paper and looking back at the screen where the data is being entered. Further, in addition to being tedious, this process is also prone to introducing error into the entered data.

In recent years, documents have increasingly been scanned into a digital format prior to processing data in an attempt to handle the paper-based information more efficiently. Once scanned, forms processing applications are typically used to collect and transfer the data contained from the digital copies of these paper documents into the information systems that require it. The conventional process employed to accomplish this task usually comprises several steps. First, a database is constructed within the forms processing application to temporarily hold information gleaned from the digital documents. Next, the forms processing application uses a combination of optical character recognition (OCR) and/or handwriting recognition (HWR) technology to pre-process the information contained in the digital documents. This is followed by a step that involves human correction and verification of the pre-processed data by visually comparing it to the digital document in order to correct any interpretation errors. Finally, once corrected and verified, this data must be exported to the receiving software application in which it will be used, which usually necessitates development of a programming interface between the forms processing application and the receiving software application in order to occur.

The discussion above is merely provided for general background information and is not intended to be used as an aid in determining the scope of the claimed subject matter. Any discussion of the prior art throughout the specification should in no way be considered as an admission that such prior art is widely known or forms part of common general knowledge in the field.

### SUMMARY

A method for entering data from a digital copy of a document is provided. The method includes accessing the digital copy of the document and creating one or more segments of the digital copy. At least one segment of the digital copy is displayed such that the at least one segment is overlaid on a user interface of an application. The method also includes receiving entry of data from a user into the user interface of the application using an input device while the at least one segment is visible over the user interface.

A system for entering data from a document into an application is provided. The system includes a receiving software application adapted to display a user interface for receiving information from a user operating an input device. The system also includes a displaying software application adapted to receive a digital copy of a document segment the digital copy into one or more segments, and display a segment of the one or more segments proximate a data entry control in the user interface of the receiving software application such that the user can operate the input device to input data from the segment into the user interface. The displaying software application is independent from the receiving software application.

A method to enter a record of a digital copy of a paper document is also provided. The method includes selecting a file name control in a receiving software application designated by the receiving software application to contain the file name of a digital file. The method also includes inserting the file name of a digital copy of a paper document into the control by programmatically inserting the characters that comprise the file name into the computer's input stream and recording the file in the receiving software application by selecting an attach control in the receiving software designated to import the file name referenced in the file name control.

These and various other features and advantages will be apparent from a reading of the following Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 4 is a block diagram of a general computing environment

FIG. 2 is a flow diagram of a method for creating segments in a digital copy of a document.

FIG. 3 is a schematic diagram of an interface for creating segments in a digital copy of a document.

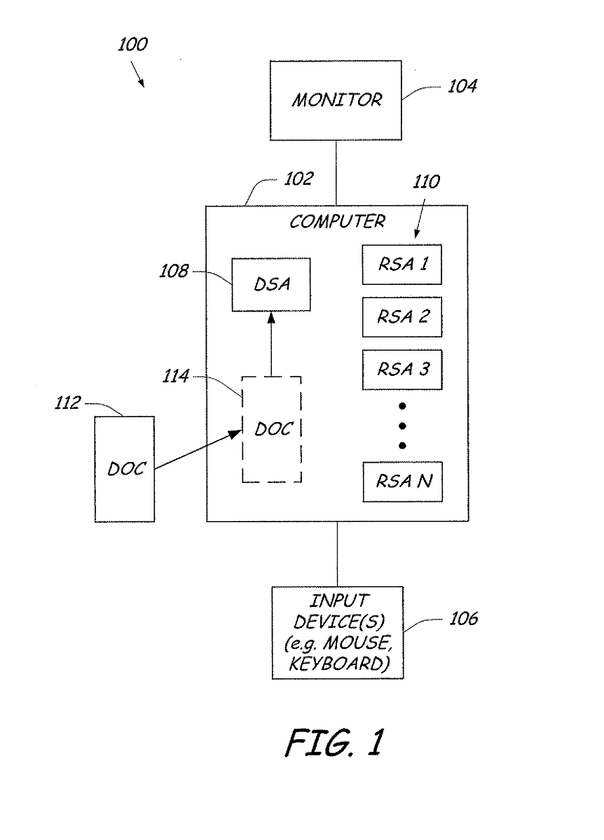

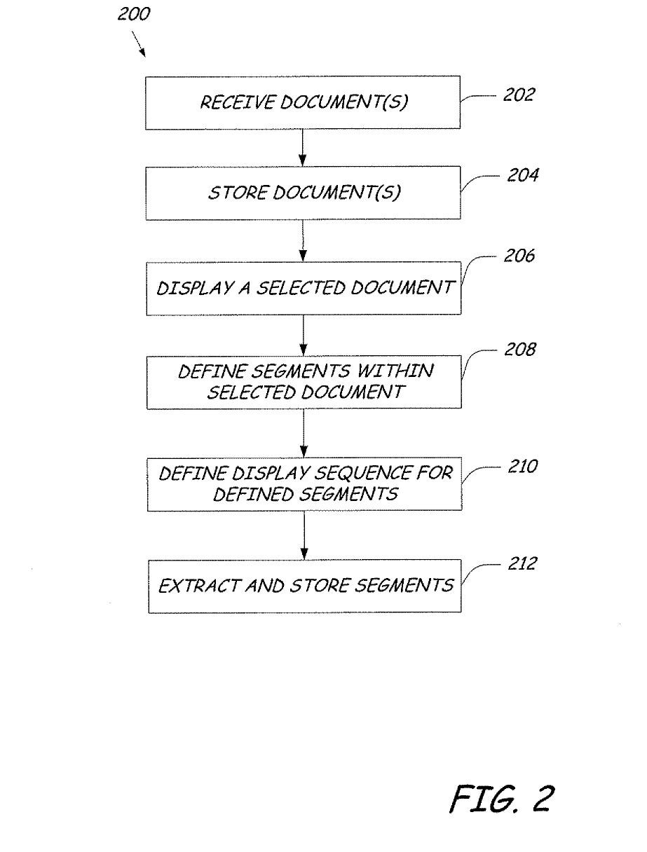

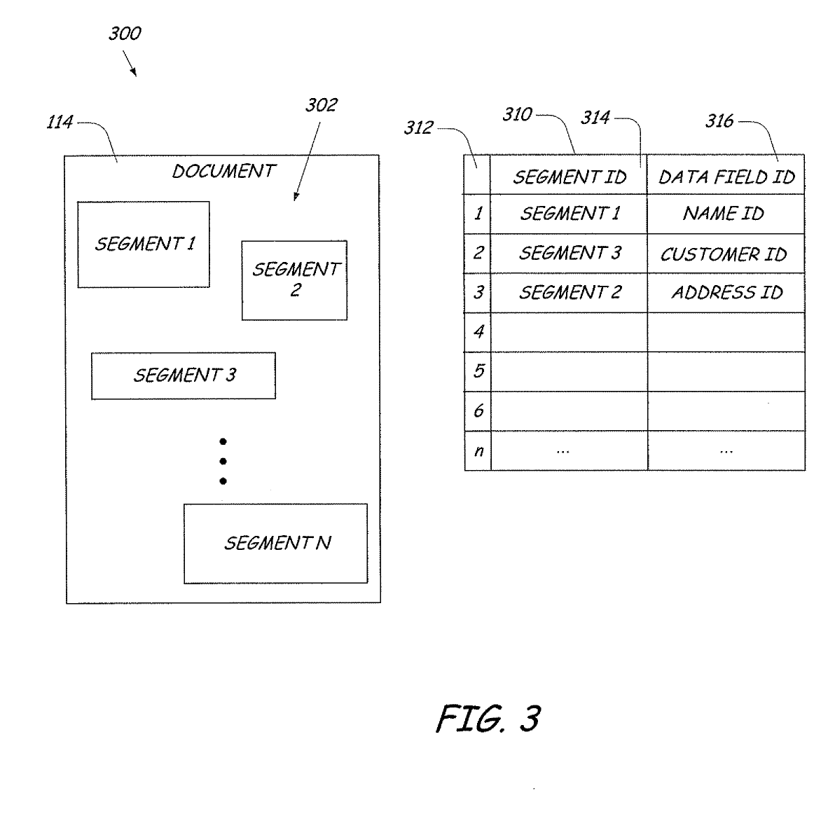

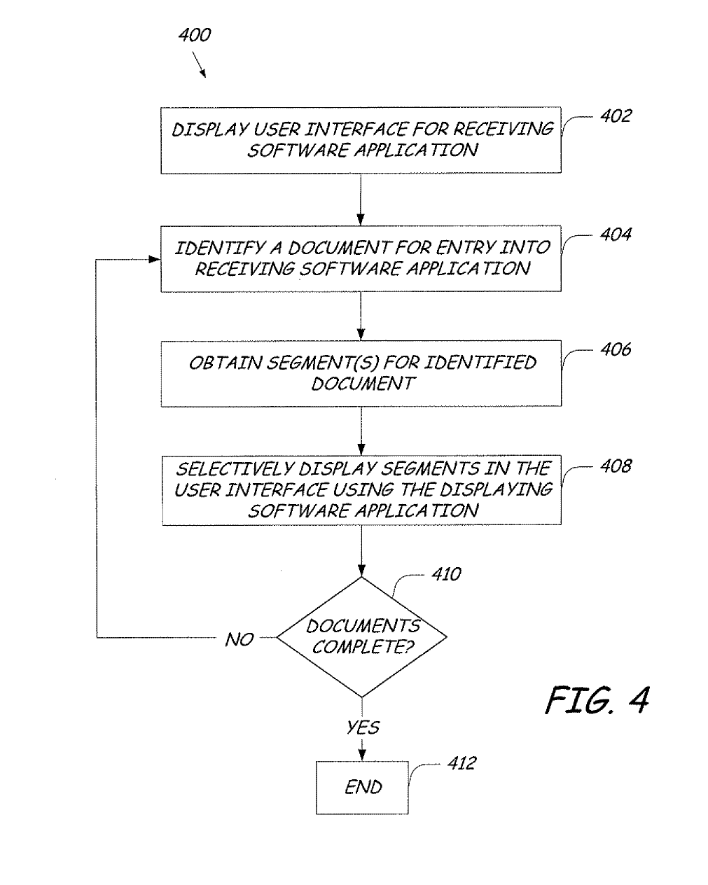

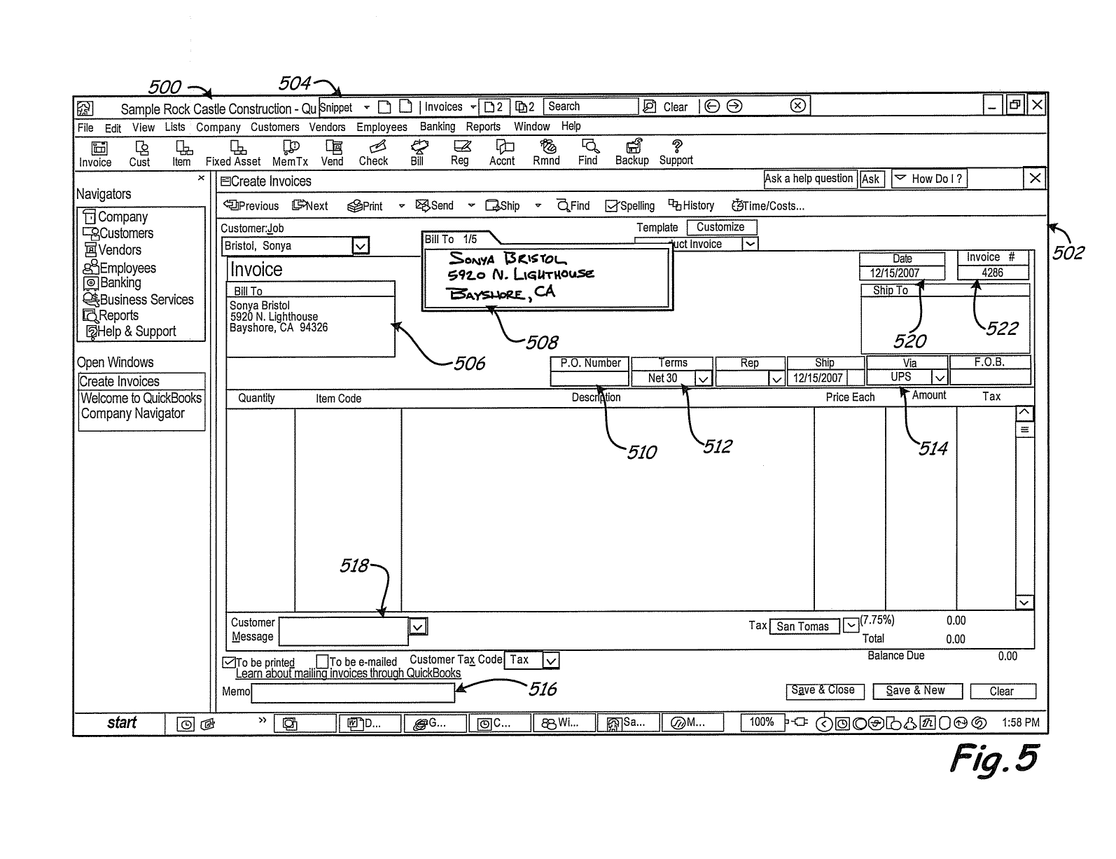

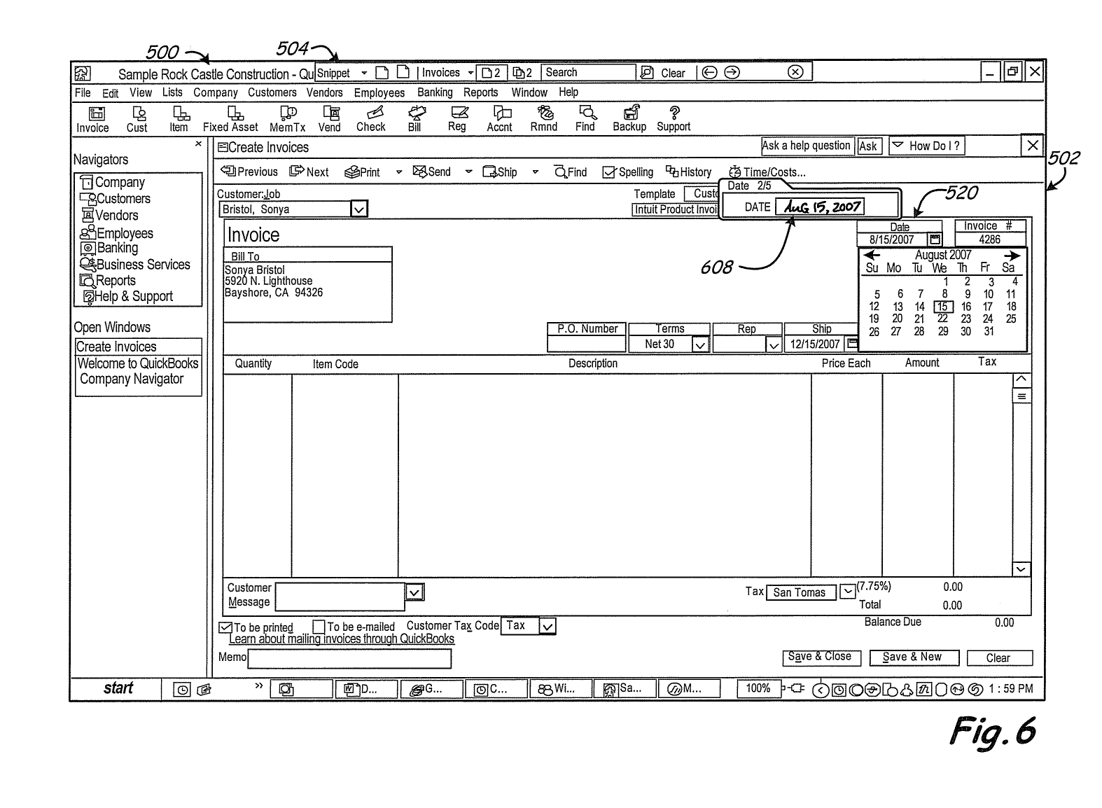

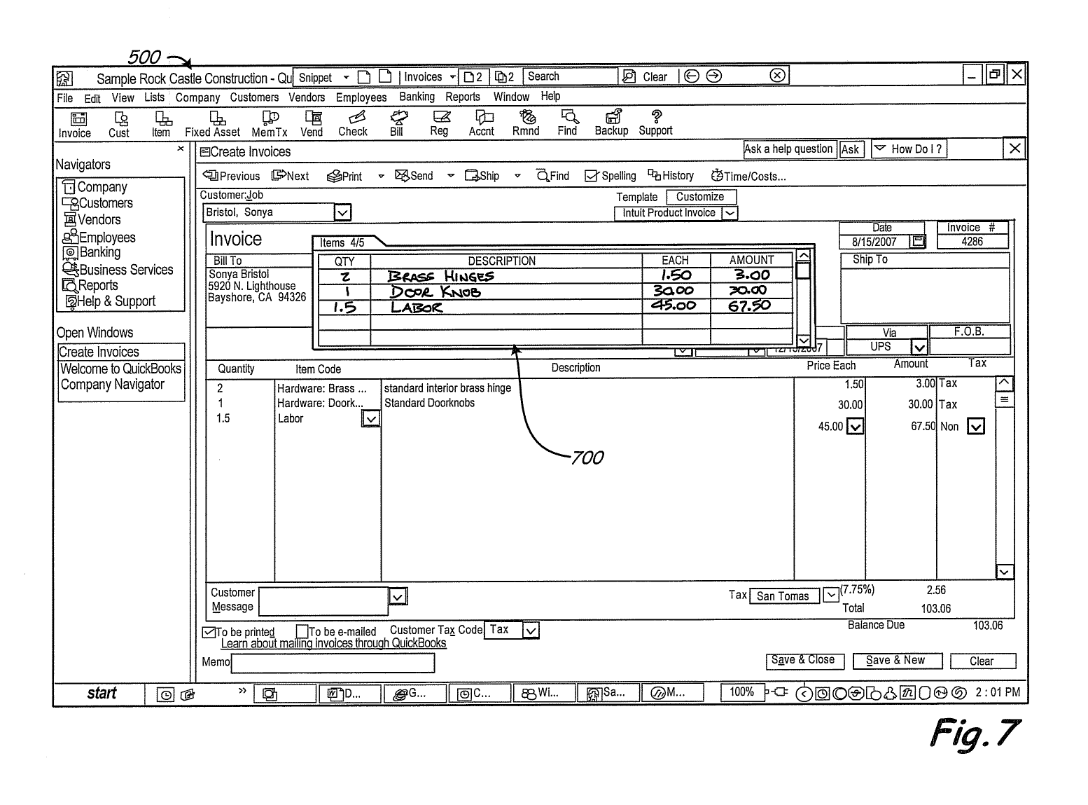

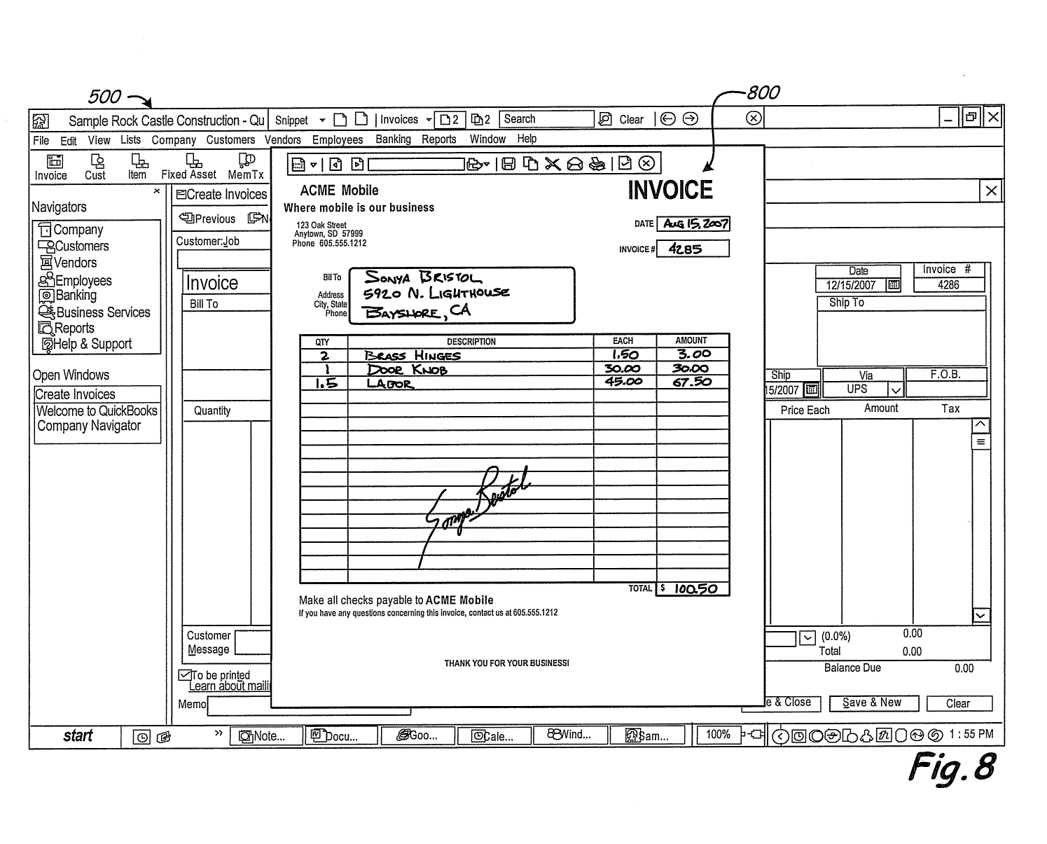

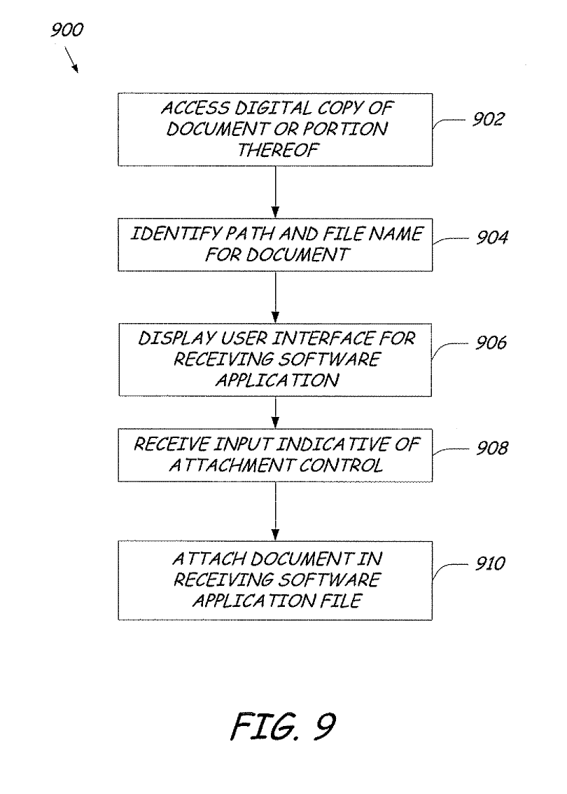

FIG. 4 is a flow diagram of a method for selectively displaying segments of a digital copy of a document.

FIG. 5 is a screen shot of a user interface displaying a billing address segment.

FIG. 6 is a screen shot of a user interface displaying a date segment.

FIG. 7 is a screen shot of a user interface displaying an items segment.

FIG. 8 is a screen shot of a user interface displaying an invoice.

FIG. 9 is a flow diagram of a method for attaching a document in a file.

### DETAILED DESCRIPTION OF ILLUSTRATIVE EMBODIMENTS

FIG. 1 is a block diagram illustrating a general computing environment 100 that includes a computer 102, a monitor 104, and one or more input devices 106. Computing environment 100 is one example of a computing system environment and is not intended to limit the scope of the concepts described herein. Changes can be made to the computing environment without departing from the spirit and scope of the present disclosure.

Examples of computing environment 100 include a personal computer, a server computer, hand-held and laptop devices, microprocessor-based systems, and programmable consumer electronics, to name a few. In the illustrated embodiment, computing environment 100 includes computer-executable instructions, such as program modules, executable by computer 102 and stored in computer readable media, such as computer readable transmission media and computer readable storage media including volatile and nonvolatile, removable and non-removable media. Examples include, but are not limited to, RAM, ROM, EEPROM, CD-ROM, DVD, flash memory, magnetic storage devices, or any other component configured to stored data which can be accessed by computer 102. Program modules include components, routines, applications, programs, and the like, that perform particular tasks and/or functions within computing environment 100. However, it is noted that some embodiments described herein can be implemented in a distributed computing environment. For example, computer 102 can be connected via a network (e.g., the internet) to remote processing devices and/or storage devices configured to perform some or all of the tasks and functions within computing environment 100. For instance, computer 102 can be connected to remote processing devices and/or storage devices using a wired or wireless connection.

In the embodiment illustrated in FIG. 1, the computer 102 is adapted to display information on monitor 104 such that a user operating input device(s) 106 can interact with computer 102. Examples of input device(s) 106 include, but are not limited to, a keyboard, mouse, trackball, touch pad, microphone, scanner, joystick, game pad, to name a few. Input device(s) 106 are generally connected to computer 102 through a user input interface or other interface such as a parallel port or universal serial bus (USB). Further, monitor 104 is generally connected to computer 102 through a video interface. Computing environment 100 can also include other output devices such as speakers and/or printers connected to computer 102 through one or more output interfaces.

Computer 102 includes a displaying software application (DSA) 108 and one or more receiving software applications (RSA) 110. An exemplary receiving software application 110 can be any application associated with computer 102 that is configured to receive data input from a user. A user can manipulate one or more of the input device(s) 106 in order to enter data from a paper document 112 into a user interface of any of the receiving software applications 110. For example, a user can utilize a keyboard and/or a mouse to enter data, such as text, into a data entry control in a user interface of one or more receiving applications 110. A data entry control is an element of a graphical user interface of a receiving software application 110 and can include, for example, a window, text box or field, list box, drop-down list, combo box, check box, toggle button, radio button, icon, and scroll bar, to name a few.

Computer 102 includes a digital copy 114 of paper document 112, wherein the digital copy 114 can be any initial format such as, but not limited to, tiff (tagged imaged file format), .png (portable network graphics), .jpg (JPEG interchange format), .bmp (bitmap file format), .gif (graphics interchange format), .pdf (portable document format), to name a few. It is appreciated that the digital copy 114 could be created using various means to create digital representations of paper documents, including, but not limited to, a scanner or a digital pen utilizing Anoto functionality, such as that sold by ANOTO AB of Lund, Sweden. Although herein discussed and illustrated as a single document, multiple documents can also be processed together or separately as discussed herein.

Displaying software application 108 is configured to be utilized to display portions or all of digital copy 114 as a user operates any of the receiving software applications 110. As a result, display of various portions of digital copy 114 can assist the user in performing data entry of information within the paper document 112. An exemplary digital copy 114 of a document includes one or more segments (also referred to as “snippets”) representing one or more pieces of information that can be utilized for data entry into one or more of the receiving software applications 110.

While displaying a user interface for a receiving software application 110, one or more segments of digital copy 114 can be selectively displayed therein, for example by overlaying the one or more segments on the user interface of the receiving software application 110. Selective display of the segments of digital copy 114 can be a function of a display sequence order for a plurality of segments of digital copy 114. For example, segments of digital copy 114 can be sequentially displayed based on an order that is pre-defined by a user. To illustrate, in one embodiment one or more segments of digital copy 114 are displayed such that the one or more segments are visible over the user interface while the user enters data into the user interface. In this manner, data can be manually entered by a user into any of the receiving software applications 110 using one or more of the input device(s) 106 while segment(s) of the digital copy 114 are viewable by the user. Allowing the data contained in the segments to be quickly and easily entered directly into the receiving application can significantly reduce or eliminate the need to format the data and/or create a temporary database for validated data before importing the data into the receiving software application. Further, allowing the data contained in the segments to be entered directly into the receiving application can also significantly reduce or eliminate the need to employ recognition technology and/or validate recognized data.

Further, the displaying software application 108 can operate independently from any of the plurality of receiving software applications 110. Thus, displaying software application 108 can be designed and implemented separately and independently of the receiving software applications 110. In one embodiment, one or more segments of digital copy 114 can be displayed by displaying software application 108 with respect to multiple receiving software applications 110, for example as a user switches between multiple receiving software applications 110.

For instance, particular segment(s) of digital copy 114 can be overlaid on a first user interface of a first receiving software application 110 (e.g. RSA 1). A user can enter data into the first user interface while the segment(s) are visible to the user. A user can then select (e.g., activate) a second receiving software application 110 (e.g. RSA 2). A second user interface of the second receiving software application 110 is displayed to the user with the segment(s) of the digital copy 114 overlaid on the second user interface. In this manner, the segment(s) of digital copy 114 remain visible to the user as the second receiving software application is activated. The user can then enter data into the second receiving software application 110 with the segment(s) of digital copy 114 overlaid on the second user interface. This process can be implemented for any number of additional RSAs 110.

Although interaction between the displaying software application 108 and any of the receiving software applications 110 is possible, the independent operation of displaying software application 108 does not require foreknowledge of the user interface or data structure of the receiving software application(s) 110. Operation of DSA 108 and any of the RSA(s) 110 can carry on without interaction from other applications.

FIG. 2 is a flow diagram illustrating one embodiment of a method 200 for creating segments of a digital copy of a document, such as digital copy 114 illustrated in FIG. 1. The created segments can be stand-alone files, such as graphics files, or provide a reference for the digital copy. In one example, coordinates form a reference as to where a particular segment is located with respect to a page in the digital copy. The coordinates can identify a box for which to position within the digital copy such that an extra copy of the graphics for the segment is not needed. Method 200 is configured to be implemented by a displaying software application, such as DSA 108. Method 200 is described with respect to FIG. 1 for illustration purposes and is not intended to limit the scope of the concepts described herein.

At step 202, a digital copy 114 of a document 112 is received. As discussed above, digital copy 114 of paper document 112 can be in any suitable format. In one embodiment of step 202, digital copies of a plurality of documents are received. Each document received at step 202 can be stored at step 204, for example by a file name and/or file path. For instance, the document(s) can be stored in a data storage component associated with computer 102.

The digital copies of documents stored at step 204 can represent any type and format of document. Further, each document can include one or more segments having handwritten and/or typed data. Each of the segments can represent one or more pieces of information that can be utilized for data entry into a receiving software application(s) 108. The segments can vary in size and position as well as contain one or more pieces of data. For example, one or more of the digital copies received at step 202 can represent a paper document including a completed (or partially completed) form, such as a sales invoice form, job application form, college application form, income tax form, and/or business form, to name a few. Segments can include, for example, a handwritten (or typed) name, address, phone number, order number, part description, identification number, among others. Further, segments can also include graphics such as pictures, images, icons, etc. In one embodiment, documents stored at step 204 can be associated with particular folders (e.g., file path) in a data storage component based on a type, format, and/or layout for the documents. For example, documents of different types (e.g., invoice, subscription request, application form, etc.) can be stored in different folders. In another example, documents for a particular constituent (e.g., a particular client, job, application, task, etc.) can be stored in the same and/or associated folder(s). As discussed above, the segments can form stand-alone graphics images or be noted by reference such as positional coordinates on a page.

Further, in one embodiment of step 202, one or more of the documents stored at step 204 can include a template document or form. For instance, an exemplary template form can include a sales invoice form, an application form, a business form, etc., having one or more data entry fields that have not been populated with data. In one embodiment a template document or form received at step 202 represents one or more other documents and/or forms received at step 202. For example, a template form can be associated with one or more completed (or partially completed) forms including handwritten and/or typed data stored at step 204. To illustrate, a plurality of digital copies of documents received at step 202 can include a template sales invoice form and one or more completed sales invoice forms that are similar in layout and format to the template sales invoice form and include handwritten and/or typed data entered into fields of the forms.

At step 206, one or more selected documents to be segmented are displayed. For instance, a user can utilize input device(s) 106 to select one or more documents stored at step 204. The selected document(s) can be a first document of a collection of documents, such as a completed form or a template. The selected document(s) are displayed to the user, such as on monitor 104.

At step 208, segments within the selected document(s) are defined. As discussed in further detail below with respect to FIG. 3, the selected documents can be processed into one or more segments depending on the format and layout of the document. In one embodiment of step 208, the displaying software application 108 can be configured to define segments within a document based on a user input. For example, as discussed below, the displaying software application 108 can be configured to display a document or template and receive a user selection input that identifies a position, size, and/or orientation of one or more segments within the document (e.g. a user can click and drag a window). Further, each segment defined at step 208 can be associated with a category or type of information, such as a label that identifies a type and/or quality of information associated with the segment. Examples of labels include “name”, “address”, “Phone number”, “order number”, “quantity”, “description”, “other”, to name a few. Alternatively, or in addition, identification of segments and/or labels at step 208 can be at least partially automated. For example, the displaying software application 108 can be configured to automatically identify segments with the document(s) based on a position and layout of information within the document.

At step 210, a display sequence is associated with the segments defined at step 208. As will be discussed in further detail below, the display sequence can be utilized by the displaying software application 108 to selectively display the segments for entry of data into one or more RSA(s) 110. The display sequence can comprise an ordered list of the segments and/or can indicate that multiple segments are to be displayed simultaneously.

In one embodiment, after completion of steps 208 and 210 for a selected document, the user can utilize a control to indicate that the segment and sequence definitions for the selected document have been completed. For example, the user can select a “form complete” control button. At step 212, segments are extracted from the document and stored based on the segments defined at step 208. The segments can be stored in a graphical format as positional coordinates, or in any other manner as desired. When stored as positional coordinates, the segments can be generated in real-time as a new document is displayed by DSA 108.

The process of defining segments at steps 208 and 210 can be repeated for additional document types. To illustrate, a collection of documents can include a plurality of documents having different types (e.g., invoice, subscription request application form, etc.). For example, a plurality of forms (e.g., sales invoice forms, job forms, application forms, etc.) having differing formats and/or layouts can be included in the plurality of documents received at step 202. In one embodiment, the process of defining segments at steps 208 and 210 is performed once for each document type. In one example, the user can select a “new form” or “next form” control button to display one or more additional documents of a particular type (e.g., a document having a particular format and layout). Steps 208-210 are performed for the additional documents. Steps 206-212 can be repeated for any remaining document types as desired. Using the segment and/or sequence definitions at steps 208 and 210, the displaying software application 108 extracts and stores information from each document at step 212.

In one embodiment, the extracted segments and display sequence for the segments are stored at step 212 in a data storage component associated with computer 102. The stored segments can form coordinates and/or be associated with a file name and/or path such that the segments can be later retrieved for selective display.

In one embodiment of method 200, the segments defined at step 208 and/or display sequence defined for the segments at step 210 can be utilized to segment one or more additional documents. For instance, the segment definitions at step 208 for a first document (i.e., a complete form, a partially completed form, a template form, etc.) can be utilized to segment additional documents, such as additional stored documents having a similar format and layout. As discussed above, the documents received at step 202 can include multiple documents having the same, or substantially similar, format. For instance, the plurality of documents received at step 202 can include one or more similar documents (or forms) each completed by different (or the same) entities. In this embodiment, one or more segments are created and stored at step 212 for each of the similar documents (or forms) using the definitions established at steps 208 and/or 210 for a first document. This creation could involve the determination of coordinates that is used for all documents of a particular type.

To further illustrate method 200, FIG. 3 is a diagram of an exemplary interface 300 of displaying software application 108 for forming segments of a digital copy 114 of a document, such as paper document 112. FIG. 3 illustrates an exemplary digital copy 114 of a document and a segment sequence table 310.

Digital copy 114 includes a plurality of segments 302 (also referred to as “snippets”) denoted as segment 1, segment 2, segment 3 . . . segment N. Each of the segments can represent one or more pieces of information that can be utilized for data entry into one of the receiving software applications 110. The segments can vary in size and position as well as contain one or more pieces of data. Coordinates for the segments can be stored so as to access the segments for each document. The digital copy 114 can be processed into one or more segments depending on the format and layout of the paper document 112. For example, the digital copy 114 can be separated into isolated segments that illustrate a handwritten name, hand written address and hand written phone number of information for entry into one or more of the receiving software applications 110. Further, segments can also include typed data and/or graphics such as pictures, images, icons, etc.

A user interacts with interface 300 to define segments 302. For example, input device(s) 106 (such as a keyboard, mouse, touchpad, touchscreen, trackball, microphone, etc.) can be utilized to enable the user to define each segment 302. For example, using a selection tool, the user can define a position, size, and/or orientation of each segment within the document 114, such as by drawing a box around a desired portion of document 114. The user can define segments in any desired manner. For instance, the user can define a segment 302 by highlighting a single piece of data, such as a name or a date. Further, the user can define a segment 302 by highlighting multiple pieces of data, such as a customer block including a name, ID, address, etc.

For each segment 302 defined by the user, an entry is created in table 310. Table 310 comprises a user-ordered list of segments 302 of document 114 arranged in a desired display sequence order 312. Each entry of table 310 illustratively includes a segment ID 314 and a data field ID 316. Segment ID 314 is an identifier that identifies a particular defined area of document 114, such as a an identifier associated with a particular defined segment 302 (e.g., “segment 1”, “segment 2”) and/or an identifier that indicates the position of a particular defined segment 302 in document 114. During subsequent display of the segments (such as that described in FIG. 4), table 310 can be utilized to sequentially display the segments in a defined order. In the illustrated embodiment, the segments are configured to be displayed in the order “segment 1”, “segment 3,” “segment 2.” However, any number of entries can be provided in table 310 in any sequence order 312.

Table 310 can also include a data field ID 316 that is a label identifying a type or quality of information associated with the particular segment associated with the entry in table 310. For example, a segment defined by segment ID 310 can be associated with a category of information, such as a label that identifies a type and/or quality of information associated with the segment. Examples of labels can include “name”, “address”, “phone number”, “order number”, “quantity”, “description”, “other”, to name a few. Each data field ID 316 can be predefined, user-defined, and/or automatically generated by the displaying software application 108. The label for the segment(s) can be displayed during data entry.

The segments created by method 200 (e.g., segments 302) and display sequence defined for the segments (e.g., data stored in table 310) can be stored in a storage memory, such as a storage memory associated with computer 102, and utilized for subsequent selective display of the segments. For example, FIG. 4 is a flow diagram of a method 400 for displaying the segments created by method 200. At step 402, a user interface for the receiving software application is displayed. For example, the receiving software application could be Microsoft Excel, Microsoft Word, Microsoft Access, Microsoft Internet Explorer, QuickBooks, Quicken, Mozilla Firefox, etc. or any other software application that can receive and/or store data.

At step 404, a document for entry into the receiving software application is determined. For example, using an interface of a displaying software application, such as DSA 108, a user identifies a document having segments created at step 212. For instance, in a billing application, a user may need to create a number of different invoices. Each invoice may have a paper document associated therewith that is used for an entry into the billing application. The document includes the plurality of segments for the digital document as created by method 200.

In one embodiment of step 404, a control, such as a menu and/or toolbar, is provided in a user interface to identify and select one or more documents for entry into the receiving software application. The control can include a selection control to enable a user to interactively select a particular document (or documents). Further, the control can also include a display (e.g., a label, tag, etc.) that provides an identification for the document (or documents).

At step 406, segment(s) are obtained for the identified document for entry into the receiving software application. In one example, the segments of the document can be generated from storage memory using, for example, a file name and/or path associated with the identified document and/or coordinates of the segments identified, for example using method 200 of FIG. 2.

At step 408, the segments are selectively displayed in the receiving software application user interface using the displaying software application. The segments can be displayed individually or a plurality of segments can be displayed simultaneously. The display is such that the segments can be overlaid with respect to the user interface of the receiving software application and appear proximate a field for entry into the receiving software application. For example, one or more segments can be positioned, either automatically or manually, proximate a data entry control within the user interface. For instance, a user can be allowed to position the one or more segments displayed as desired. The position of the one or more segments can be stored and used for subsequent display of segments. For example, a position of segments for a first document can be stored and utilized to position segments for a second document.

Selective display of the segments can also be performed as a function of keystrokes input by the user. For example, the user may wish to enter a name, address and phone number from a paper document. A user may enter a first field, which is associated with the name. At this point, the name segment is selectively displayed to the user such that data input into the application can be made by the user. The user may wish to enter the next field, which is the address field, and does so by providing a keystroke, such as the tab key. The tab key notifies the displaying software application that the next segment should be used, and thus selectively display the next segment, which is the address associated with the name in the record. This selective display can also be performed for the phone number or any other information such as date by notes, etc. The selective display can also be performed as a function of user input.

In one embodiment, the selective display of segments at step 408 is performed as a function of a display sequence defined for the segments, such as the display sequence defined at step 210 (illustrated in FIG. 2) and/or stored in a display sequence table, such as table 310 (illustrated in FIG. 3). In one example, a user can utilize a control, such as a “hot key” on a keyboard, a mouse, a touchpad, to indicate that a segment is to be displayed. The display sequence stored in table 310 is accessed and utilized to determine a next segment to be displayed.

At step 410, it is determined whether there are any records left for entry. If further documents need to be entered, method 400 can return to step 404 wherein the segments for a next document can be selectively displayed. Otherwise, method 400 can end at step 410.

During selective display of the segments, a user can visually see the information in the segments for quick and easy manual data entry of information in the segments into the receiving software application. The user can position the segments as desired such that segments can be positioned proximate a desired field for entry. Additionally, since the displaying software application can operate independently from one or more of the receiving software applications, the segments can be overlaid on any user interface of the receiving software application.

FIG. 5 is a screen shot of one embodiment of a user interface 500 for displaying segments of a digital copy of a document. User interface 500 is configured to implement one or more steps of method 400 and can be associated with a receiving software application, such as one or more of the receiving software applications 110 illustrated in FIG. 1. User interface 500 includes a data entry window 502 Further, a segment navigation bar 504 is provided. Segment navigation bar 504 is associated with a display software application for displaying segments of documents, such as displaying software application 108 illustrated in FIG. 1. As similarly discussed above, in one embodiment the displaying software application for displaying segments can operate independently from the receiving software applicant configured to receive user input of data from the segments. Segment navigation bar 504 includes controls that enable a user to navigate between documents and/or segments to be displayed.

In the illustrated example, user interface 500 is a billing application for entering data into an invoice. Data entry window 502 includes one or more data entry controls such as, for example, a window, text box or text field, list box, drop-down list combo box, check box, toggle button, radio button, icon, or scroll bar. In the illustrated embodiment data entry window 502 includes a name/address section 506, where a user can enter a name and address of a party to be billed.

After entering into portion 506, for example using a pointing device or “hot key,” a segment 508, illustratively including address data, can be conveniently displayed next to portion 506 such that the user can enter in an address for the invoice. The displaying software application can be configured to selectively display segments based on user input, for example by activating a control on segment navigation bar 504 or a “hot key” (e.g., a tab key). Further, the displaying software application can be configured to display a next segment (for example based on a predefined display sequence) when a subsequent data entry control is selected or activated.

Segment 508 includes a digital version of a segment for the digital document. In one embodiment segment 508 includes a label that contains information identifying the type and/or source at the data contained in segment 508. As illustrated segment 508 is shown to contain billing address information obtained from the digital document, and thus a label such as “bill to” can be provided as a visual indication to the user. The label can be a label or tag identified by the user, such as at step 306 illustrated in FIG. 3. In FIG. 5, the label appears in an upper left-hand corner of segment 508. An indicator of what number segment in a sequence the segment is, as well as the total number of segments, is provided.

Segment 508 can be automatically positioned with respect to portion 506. For example, the displaying software application can position segment 508 using position information stored for previously displayed segments. Alternatively, or in addition, a user can provide an input, such as through a mouse or keyboard, to position segment 508 with respect to user interface 500. Further, segment navigation bar 504 can be used to display different segments, for example in a sequential and/or simultaneous manner. Selective display of segments is performed, in one embodiment, as a function of a defined display sequence for the segments. For example, a display sequence such as that described above with respect to FIG. 3 can be utilized. Selection of segments to be displayed can be a function of user interaction with interface 500, such as by using navigation bar 504, activating a “hot-key,” and/or entering a different data entry control in interface 500, such as controls 510-522. In one embodiment, a plurality of segments are displayed at the same time over user interface 500. Data from the different segments can be entered into portion 506 or entered into other data entry controls such as controls 510-522, among others. In one embodiment, a user can provide an input to resize and/or scroll within the segment. For example, a scroll bar can be provided proximate the displayed segment.

In another embodiment, an entire digital copy of a document is displayed over the user interface 500. As discussed above, a scroll bar and/or resize command can be provided to enable a user to scroll through the entire digital copy and/or alter the size of a window displaying the digital copy.

In accordance with one embodiment, a segment such as segment 508 can be positioned over any number and type of receiving software application. As discussed above, the displaying software application that displays segment 508 is independent of the receiving software application and is not required to receive information from the receiving software application to display segment 508. To illustrate, segment 508 can be displayed over a first receiving software application such as a Microsoft Excel spreadsheet. A user can switch to another receiving software application (such as another Excel spreadsheet, a Microsoft Word document, an Internet browser, a billing application, to name a few) while segment 508 remains overlaid on the second receiving software application.

FIG. 6 is a screen shot of user interface 500 in which a user has highlighted a date portion 520 within data entry window 502. Since date portion 520 is highlighted, a displaying software application can display a segment 608, which includes a handwritten date from a copy of an associated paper document as well as its associated label “date”. When entering data into date portion 520, the user can easily see and validate the date that should be entered into the receiving software application. Navigation bar 504 can be used to navigate through various segments of the document. For example, the user can choose to move to the previous segment or the next segment within a document in a convenient manner. Further, navigation bar 504 can be used to select a different document for display. As further examples of interface 500, FIG. 7 is a screen shot of user interface 500 with an “items” segment 700 and FIG. 8 is a screen shot of user interface 500 with the invoice 800 shown.

FIG. 9 is a flow diagram of a method 900 for attaching a file within a receiving software application. Method 900 begins at step 902 wherein a digital copy of a document or a portion thereof is accessed. At step 904, a path and file name for the document are identified. At step 906, a user interface for the receiving software application is displayed. Within the user interface, the user may wish to attach a file within the receiving software application. For example, a user may wish to attach a signed contract to an invoice. At step 908, input of an attachment control is received from a user. For example, the input could be a simple key such as a function key. Alternatively, or in addition to, the path and file name for the document can be loaded into a clipboard feature of an operating system. The clipboard feature allows pieces of information (e.g. path and file name) to be temporarily stored for later use. Thus, a user can simply paste the information from the clipboard as desired. Thus, a user does not need to browse and search for the appropriate file for attachment. At step 910, the file is attached within the receiving software application.

It is to be understood that even though numerous characteristics and advantages of various embodiments of the disclosure have been set forth in the foregoing description, together with details of the structure and function of various embodiments of the disclosure, this disclosure is illustrative only, and changes may be made in detail, especially in matters of structure and arrangement of parts within the principles of the present disclosure to the full extent indicated by the broad general meaning of the terms in which the appended claims are expressed. For example, the particular elements may vary depending on the particular application for the system while maintaining substantially the same functionality without departing from the scope and spirit of the present disclosure and/or the appended claims.

What is claimed is:

1. A method for entering data from a digital copy of a document, the method comprising:
accessing the digital copy of the document;
creating one or more segments of the digital copy;
displaying at least one segment of the digital copy such that the at least one segment is overlaid on a user interface of an application; and
receiving entry of data from a user into the user interface of the application using an input device while the at least one segment is visible over the user interface.

2. The method of claim 1, wherein the application is a receiving software application, and wherein displaying comprises:
displaying the at least one segment proximate a relevant data entry control in the user interface of the receiving software application.

3. The method of claim 1, and further comprising:
receiving a user input; and
positioning the at least one segment with respect to the user interface based on the user input.

4. The method of claim 3, and further comprising storing information indicative of a position of the at least one segment relative to the user interface.

5. The method of claim 1, where displaying comprises sequentially displaying a plurality of segments of the digital copy.

6. The method of claim 5, wherein creating one or more segments of the digital copy comprises creating a plurality of segments of the digital copy and defining a display sequence for the plurality of segments, and wherein displaying comprises displaying the plurality of segments sequentially based on the display sequence.

7. The method of claim 6, and further comprising:
receiving a user input that activates a control; and
displaying the at least one segment based on the activated control.

8. The method of claim 7, wherein receiving a user input comprises receiving an indication of a keystroke from an input device, and wherein displaying comprises displaying the at least one segment in response to the indication.

9. The method of claim 7, wherein receiving a user input comprises activating a control that modifies a quantity of data in one or more of the segments.

10. The method of claim 1, wherein displaying comprises displaying a plurality of segments of the digital copy at the same time.

11. The method of claim 1, and further comprising providing a control associated with at least one segment, the control being configured to at least one of scale and scroll the at least one segment.

12. The method of claim 1, where displaying comprises displaying the at least one of segment with a label that identifies a type or quality of data associated with the data contained in the at least one segment.

13. The method of claim 1, and further comprising:
obtaining digital copies of a plurality of documents;
defining segments for a digital copy of a first document of the plurality of documents;
creating segments of the digital copy of the first document; and
creating segments of digital copies of one or more additional documents based on the segments defined for the digital copy of the first document.

14. The method of claim 1, wherein the digital copy represents at least one page of a paper document, and wherein creating one or more segments of the digital copy comprises:
creating at least one segment that represents a portion of the page.

15. The method of claim 1, wherein creating one or more segments of the digital copy comprises:
creating at least one segment that represents a portion of the image of the digital copy.

16. The method of claim 1, wherein the application is a first receiving software application, the method further comprising:
receiving an indication of a second receiving software application;
in response to the indication, displaying a user interface of the second receiving software application such that the at least one segment of the digital copy is overlaid on a user interface of an application; and
receiving entry of data from the user into the user interface of the second receiving software application using an input device while the at least one segment is visible over the user interface of the second receiving software application.

17. The method of claim 1, and further comprising:
selecting a file name control in the receiving software application; and
inserting a file name associated with the digital copy into the receiving software application.

18. The method of claim 1 wherein creating one or more segments of the digital copy includes defining positional coordinates for the one or more segments.

19. A system for entering data from a document into an application, the system comprising:
a receiving software application adapted to display a user interface for receiving information from a user operating an input device; and
a displaying software application adapted to receive a digital copy of a document, segment the digital copy into one or more segments, and display a segment of the one or more segments proximate a data entry control in the user interface of the receiving software application such that the user can operate the input device to input data from the segment into the user interface, wherein the displaying software application is independent from the receiving software application.

20. The system of claim 19, and further comprising a plurality of receiving software applications each adapted to display a user interface for receiving information from a user, wherein the displaying software application is configured to be operated independently from each of the plurality of receiving software applications.

21. The system of claim 20, wherein the displaying software application is configured to display the segment such that the segment is overlaid on a first user interface of a first receiving software application such that the user can enter information into the first user interface while the segment is visible to the user, and wherein the system is configured to receive a user selection input indicative of a second user interface of a second receiving software application and in response display the second user interface such that the segment is overlaid on the second user interface, wherein the user can enter information into the second user interface while the segment is visible to the user.

22. The system of claim 19, wherein the displaying software application is configured to display the segment such that the segment is overlaid on the user interface, and wherein the one or more segments are selectively displayed over the user interface based on a user input.

23. The system of claim 20, wherein the one or more segments are selectively displayed over the user interface in a sequential manner based on a display sequence that is predefined for the one or more segments.

24. The system of claim 19, wherein the displaying software application is configured to display a plurality of the one or more segments simultaneously over the user interface.

25. A method to enter a record of a digital copy of a paper document, comprising:
selecting a file name control in a receiving software application designated by the receiving software application to contain the file name of a digital file;
inserting the file name of a digital copy of a paper document into the control by programmatically inserting the characters that comprise the file name into the computer's input stream; and
recording the file in the receiving software application by selecting an attach control in the receiving software designated to import the file name referenced in the file name control.

26. The method of claim 25 wherein the file name control is initiated by pressing a specified key.

27. The method of claim 25 wherein the computer's input stream comprises a clipboard feature of an operating system.
